(19) United States
(12) Patent Application Publication
(10) Pub. No.: US 2023/0327217 A1
(43) Pub. Date: Oct. 12, 2023

(54) SECONDARY BATTERY, ELECTRONIC EQUIPMENT, AND ELECTRIC TOOL

(71) Applicant: MURATA MANUFACTURING CO., LTD., Kyoto (JP)

(72) Inventors: Rikako IMOTO, Tokyo (JP); Masashi TAKAHASHI, Tokyo (JP); Hideki NAKAI, Tokyo (JP)

(21) Appl. No.: 18/136,080

(22) Filed: Apr. 18, 2023

Related U.S. Application Data
(63) Continuation of application No. PCT/JP2021/038073, filed on Oct. 14, 2021.

(30) Foreign Application Priority Data
Oct. 23, 2020 (JP) 2020-177768

(51) Int. Cl. H01M 10/0587; H01M 10/0525; H01M 4/134

(52) U.S. Cl. CPC H01M 10/0587; H01M 10/0525; H01M 4/134; H01M 2220/30; H01M 2220/20; H01M 2004/027

(57) ABSTRACT

A battery having a low internal resistance is provided. A secondary battery includes an electrode wound body, a positive electrode current collector plate, a negative electrode current collector plate, and an outer package. The electrode wound body has a structure in which a positive electrode having a band shape and a negative electrode having a band shape are stacked with a separator interposed therebetween, and are in a wound configuration. The outer package contains the electrode wound body, the positive electrode current collector plate, and the negative electrode current collector plate. The negative electrode includes, on a negative electrode foil having a band shape, a negative electrode active material covered part covered with a negative electrode active material layer, and a negative electrode active material uncovered part. The electrode wound body has a flat surface, in which portions of the negative electrode active material uncovered part that protrude from one end of the electrode wound body are bent toward a central axis of the electrode wound body to form the flat surface. The flat surface is joined to the negative electrode current collector plate. The negative electrode foil has a first major surface facing toward the central axis, and a second major surface facing away from the central axis. Where a glossiness of the first major surface is denoted as G1 and a glossiness of the second major surface is denoted as G2, G1>G2 is satisfied.

### CROSS REFERENCE TO RELATED APPLICATIONS

The present application is a continuation of PCT patent application no. PCT/JP2021/038073, filed on Oct. 14, 2021, which claims priority to Japanese patent application no. 2020-177768, filed on Oct. 23, 2020, the entire contents of which are incorporated herein by reference.

### BACKGROUND

The present application relates to a secondary battery, electronic equipment, and an electric tool.

Development of lithium ion batteries has expanded to applications that require high output power, including electric tools and electric automobiles. One of methods to achieve high output power is high-rate discharging in which a relatively large current is fed from a battery. In such an application, it is important to reduce an internal resistance of the battery.

For example, a battery is disclosed having a structure in which a negative electrode core-exposed portion formed at one end of a flat electrode wound body and a negative electrode current collector are resistance-welded to each other. In the battery, a surface roughness of an outer surface side of the negative electrode core-exposed portion is lower than a surface roughness of an inner surface side thereof.

### SUMMARY

The present application relates to a secondary battery, electronic equipment, and an electric tool.

The battery described in the Background section has an issue that an area of contact between the core-exposed portion of the negative electrode formed at one end of the wound electrode body and the negative electrode current collector is not sufficiently large and therefore an internal resistance of the battery is not sufficiently low.

The present application provides a battery that is low in internal resistance according to an embodiment.

In order to solve the above-described problem, the present application, in an embodiment, provides a secondary battery including an electrode wound body, a positive electrode current collector plate, a negative electrode current collector plate, and an outer package can. The electrode wound body has a structure in which a positive electrode having a band shape and a negative electrode having a band shape are stacked on each other with a separator interposed therebetween, and are wound. The outer package can contains the electrode wound body, the positive electrode current collector plate, and the negative electrode current collector plate.

The negative electrode includes, on a negative electrode foil having a band shape, a negative electrode active material covered part covered with a negative electrode active material layer, and a negative electrode active material uncovered part.

The electrode wound body has a flat surface, in which portions of the negative electrode active material uncovered part that protrude from one end of the electrode wound body are bent toward a central axis of the electrode wound body and overlap with each other to form the flat surface.

The flat surface is joined to the negative electrode current collector plate.

The negative electrode foil has a first major surface facing toward the central axis, and a second major surface facing away from the central axis.

Where a glossiness of the first major surface is denoted as G1 and a glossiness of the second major surface is denoted as G2, G1>G2 is satisfied.

According to an embodiment, a cutout is provided on a winding end side of the electrode wound body. This makes it possible to neatly bend the negative electrode active material uncovered part, thus making it possible to provide a battery free from occurrence of an internal short circuit. It should be understood that the contents of the present application are not to be construed as being limited by the effects exemplified herein.

### BRIEF DESCRIPTION OF THE FIGURES

FIG. 1 is a sectional view of a battery according to an embodiment.

FIG. 2 is a diagram describing an example of an arrangement relationship between a positive electrode, a negative electrode, and a separator in an electrode wound body.

FIG. 3 includes views A and B, where view A is a plan view of a positive electrode current collector plate, and view B is a plan view of a negative electrode current collector plate.

FIG. 4 includes views A to F which are diagrams describing an assembly process of the battery according to an embodiment.

FIG. 5 is a diagram for describing positions of laser welding marks.

FIG. 6 is a partial sectional diagram for describing Examples.

FIG. 7 is a partial sectional diagram for describing Comparative examples 1 to 3.

FIG. 8 is a partial sectional diagram for describing Comparative example 4.

FIG. 9 is a coupling diagram for use to describe a battery pack as an application example.

FIG. 10 is a coupling diagram for use to describe an electric tool as an application example.

FIG. 11 is a coupling diagram for use to describe an electric vehicle as an application example.

### DETAILED DESCRIPTION

One or more embodiments of the present application are described below in further detail, including with reference to the drawings.

The present application described herein includes examples according to an embodiment, and the contents of the present application are not limited thereto.

In an embodiment, a lithium ion battery having a cylindrical shape will be described as an example of a secondary battery.

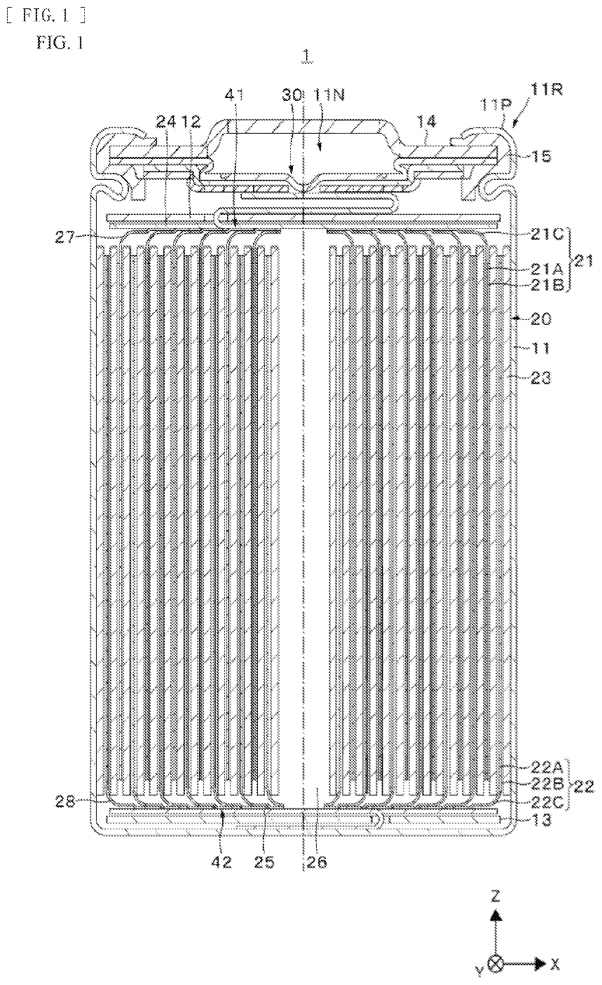

Description is given of an overall configuration of the lithium ion battery. FIG. 1 is a schematic sectional view of a lithium ion battery 1. The lithium ion battery 1 is, for example, a cylindrical lithium ion battery 1 including an electrode wound body 20 that is contained inside a battery can 11, as illustrated in FIG. 1.

The lithium ion battery 1 includes, for example, a pair of insulating plates 12 and 13 and the electrode wound body 20 inside the battery can 11 having a cylindrical shape. Note that the lithium ion battery 1 may further include, for example, one or more of devices and members including, without limitation, a thermosensitive resistive device or a PTC device and a reinforcing member, inside the battery can 11.

The battery can 11 is a member that contains mainly the electrode wound body 20. The battery can 11 is, for example, a cylindrical container with one end face open and another end face closed. That is, the battery can 11 has one open end face (an open end face 11N). The battery can 11 includes, for example, one or more of metal materials including, without limitation, iron, aluminum, and alloys thereof. Note that the battery can 11 may have a surface plated with one or more of metal materials including, without limitation, nickel, for example.

The insulating plates 12 and 13 are disk-shaped plates each having a surface that is substantially perpendicular to a central axis of the electrode wound body 20. Further, the insulating plates 12 and 13 are so disposed as to allow the electrode wound body 20 to be interposed therebetween, for example.

A battery cover 14 and a safety valve mechanism 30 are crimped to the open end face 11N of the battery can 11 via a gasket 15 to thereby provide a crimped structure 11R (a crimp structure). The battery can 11 is thus sealed in a state where the electrode wound body 20 and other components are contained inside the battery can 11.

The battery cover 14 is a member that mainly closes the open end face 11N of the battery can 11 in the state where the electrode wound body 20 and the other components are contained inside the battery can 11. The battery cover 14 includes, for example, a material similar to the material included in the battery can 11. A middle region of the battery cover 14 protrudes in a +Z direction, for example. A region other than the middle region, that is, a peripheral region, of the battery cover 14 is thus in contact with the safety valve mechanism 30, for example.

The gasket 15 is a member that is mainly interposed between the battery can 11 (a bent part 11P) and the battery cover 14 to thereby seal a gap between the bent part 11P and the battery cover 14. Note that the gasket 15 may have a surface coated with a material such as asphalt, for example.

The gasket 15 includes one or more of insulating materials, for example. Although not particularly limited in kind, the insulating material may be, for example, a polymer material such as polybutylene terephthalate (PBT) or polypropylene (PP). In particular, the insulating material is preferably polybutylene terephthalate. A reason for this is that such a material makes it possible to seal the gap between the bent part 11P and the battery cover 14 sufficiently while allowing the battery can 11 and the battery cover 14 to be electrically separated from each other.

The safety valve mechanism 30 cancels the sealed state of the battery can 11 and thereby releases a pressure inside the battery can 11, i.e., an internal pressure of the battery can 11 on an as-needed basis, mainly when the internal pressure has increased. Examples of a cause of an increase in the internal pressure of the battery can 11 include a gas generated due to a decomposition reaction of an electrolytic solution during charging and discharging.

In the cylindrical lithium ion battery, a positive electrode 21 having a band shape and a negative electrode 22 having a band shape, which are stacked on each other with a separator 23 interposed therebetween and are wound in a spiral shape, are contained in the battery can 11 in a state of being impregnated with the electrolytic solution. The positive electrode 21 includes a positive electrode foil 21A with a positive electrode active material layer provided on one surface or each of both surfaces of the positive electrode foil 21A. A material of the positive electrode foil 21A is a metal foil including, for example, aluminum or an aluminum alloy. The negative electrode 22 includes a negative electrode foil 22A with a negative electrode active material layer provided on one surface or each of both surfaces of the negative electrode foil 22A. A material of the negative electrode foil 22A is a metal foil including, for example, nickel, a nickel alloy, copper, or a copper alloy. The separator 23 is a porous insulating film. The separator 23 electrically insulates the positive electrode 21 and the negative electrode 22 from each other, and allows movement of substances including, without limitation, ions and the electrolytic solution.

The positive electrode active material layer and the negative electrode active material layer cover most of the positive electrode foil 21A and most of the negative electrode foil 22A, respectively, but do not cover, on purpose, respective parts of the foils located at and near respective one ends in a short-axis direction of the bands. Hereinafter, where appropriate, the parts not covered with the respective active material layers will be referred to as active material uncovered parts 21C and 22C, and parts covered with the respective active material layers will be referred to as active material covered parts 21B and 22B. In the electrode wound body 20 of the cylindrical battery, the positive electrode 21 and the negative electrode 22 are laid over each other and wound with the separator 23 interposed therebetween in such a manner that the active material uncovered part 21C of the positive electrode and the active material uncovered part 22C of the negative electrode face toward opposite directions.

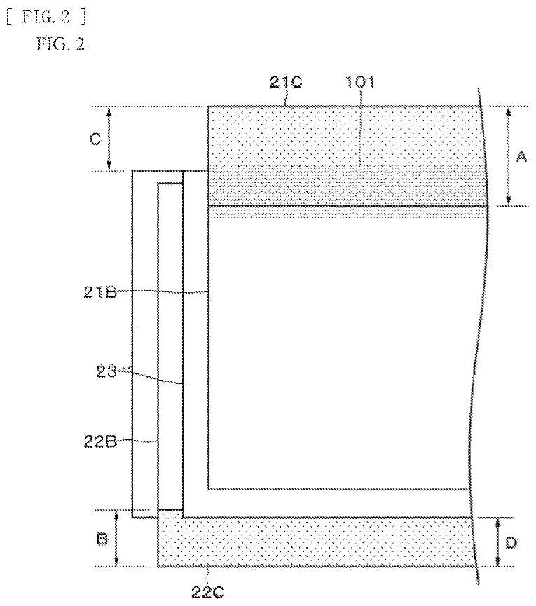

FIG. 2 illustrates an example of a pre-winding structure in which the positive electrode 21, the negative electrode 22, and the separator 23 are stacked on each other. The active material uncovered part 21C of the positive electrode (a shaded portion on the upper side in FIG. 2) has a width A, and the active material uncovered part 22C of the negative electrode (a shaded portion on the lower side in FIG. 2) has a width B. In an embodiment, it is preferable that A>B. For example, A is 7 (mm), and B is 4 (mm). A portion of the active material uncovered part 21C of the positive electrode protruding from one end in a width direction of the separator 23 has a length C. A portion of the active material uncovered part 22C of the negative electrode protruding from another end in the width direction of the separator 23 has a length D. In an embodiment, it is preferable that C>D. For example, C is 4.5 (mm), and D is 3 (mm).

The active material uncovered part 21C of the positive electrode includes, for example, aluminum, and the active material uncovered part 22C of the negative electrode includes, for example, copper. Thus, the active material uncovered part 21C of the positive electrode is typically softer, that is, lower in Young's modulus, than the active material uncovered part 22C of the negative electrode. Accordingly, in an embodiment, it is more preferable that A>B and C>D. In such a case, when portions of the active material uncovered part 21C of the positive electrode and portions of the active material uncovered part 22C of the negative electrode are simultaneously bent with equal pressures from both electrode sides, respective heights of the bent portions as measured from respective ends of the separator 23 are almost the same between the positive electrode 21 and the negative electrode 22 in some cases. At this time, the portions of the active material uncovered part 21C appropriately overlap with each other when bent, and the portions of the active material uncovered part 22C appropriately overlap with each other when bent. This makes it possible to easily join the active material uncovered parts 21C and 22C to current collector plates 24 and 25, respectively, by laser welding. In an embodiment, joining refers to coupling electrically, and a method of joining is not limited to laser welding.

In the positive electrode 21, a region of a 3-mm width including a boundary between the active material uncovered part 21C and the active material covered part 21B is covered with an insulating layer 101 (a gray region in FIG. 2). In addition, all of a region of the active material uncovered part 21C of the positive electrode that is opposed to the active material covered part 22B of the negative electrode with the separator interposed therebetween is covered with the insulating layer 101. The insulating layer 101 has an effect of preventing an internal short circuit of the battery 1 with reliability upon entry of foreign matter between the active material covered part 22B of the negative electrode and the active material uncovered part 21C of the positive electrode. In addition, the insulating layer 101 has an effect of, in a case where the battery 1 undergoes an impact, absorbing the impact on the battery 1 and thereby preventing bending of the active material uncovered part 21C of the positive electrode and occurrence of a short circuit with the negative electrode 22, with reliability.

The electrode wound body 20 has a through hole 26 at a center thereof. The through hole 26 is a hole through which a winding core for assembling the electrode wound body 20 and an electrode rod for welding are to be placed. In the electrode wound body 20, the positive electrode 21 and the negative electrode 22 are laid over each other and wound in such a manner that the active material uncovered part 21C of the positive electrode and the active material uncovered part 22C of the negative electrode face toward opposite directions. Thus, the active material uncovered part 21C of the positive electrode is localized to one end face, i.e., an end face 41, of the electrode wound body, and the active material uncovered part 22C of the negative electrode is localized to another end face, i.e., an end face 42, of the electrode wound body 20. In order to improve contact with the current collector plates 24 and 25 which serve to extract currents, the portions of the active material uncovered part 21C are bent to make the end face 41 into a flat surface and the portions of the active material uncovered part 22C are bent to make the end face 42 into a flat surface. The direction of bending is from an outer edge part 27 of the end face 41 toward the through hole 26 or from an outer edge part 28 of the end face 42 toward the through hole 26. Thus, the portions of the active material uncovered part that are located in adjacent winds in a wound state are bent and overlap with each other. As used herein, the “flat surface” includes not only a completely flat surface but also a surface having some asperities or surface roughness to the extent that it is possible to join the active material uncovered parts to the respective current collector plates.

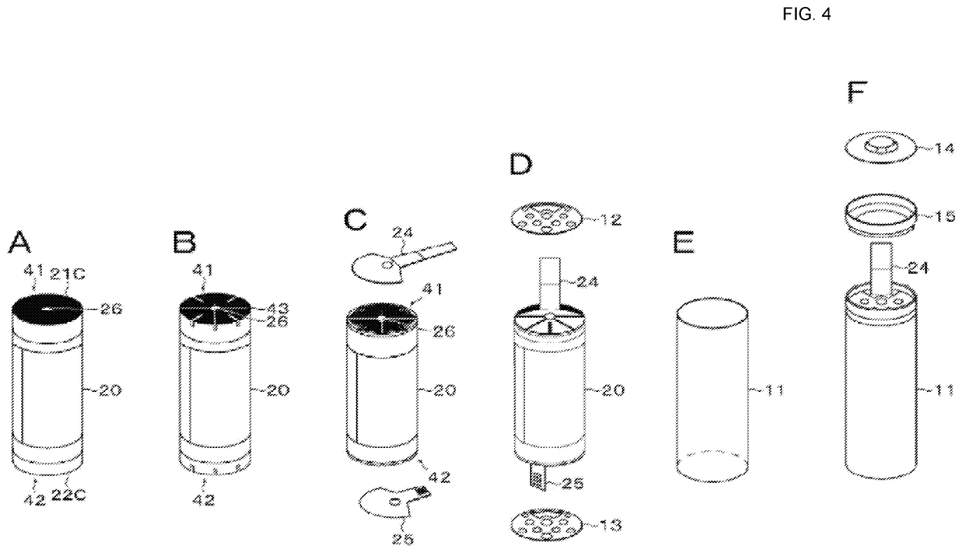

It may seem to be possible to make the end faces 41 and 42 into flat surfaces by bending the portions of the active material uncovered part 21C to overlap with each other and bending the portions of the active material uncovered part 22C to overlap with each other; however, without any processing in advance of bending, creases or voids (gaps or spaces) will develop in the end faces 41 and 42 upon bending, thus making it difficult for the end faces 41 and 42 to become flat surfaces. Here, “creases” and “voids” are unevenness in the active material uncovered parts 21C and 22C occurring when the portions thereof are bent, resulting in non-flatness of the end faces 41 and 42. To prevent the occurrence of the creases and voids, grooves 43 (see FIG. 4B, for example) are formed in advance in radial directions from the through hole 26. The grooves 43 each extend from the outer edge part 27 of the end face 41 to the through hole 26 or from the outer edge part 28 of the end face 42 to the through hole 26. The through hole 26 is positioned at the center of the electrode wound body 20. The through hole 26 is used as a hole through which a welding tool is to be placed in the assembly process of the lithium ion battery 1. Respective portions of the active material uncovered parts 21C and 22C at the beginning of winding of the positive electrode 21 and the negative electrode 22 near the through hole 26 are provided with cutouts. This is to prevent the through hole 26 from being closed by the portions of each of the active material uncovered parts 21C and 22C when they are bent toward the through hole 26. The grooves 43 remain in each of the flat surfaces even after the portions of each of the active material uncovered parts 21C and 22C are bent, and regions of each of the flat surfaces having no grooves 43 are thus joined (e.g., welded) to corresponding one of the positive electrode current collector plate 24 and the negative electrode current collector plate 25. Note that the grooves 43, as well as the flat surface, may be joined to portions of the current collector plate 24 or 25.

A detailed configuration of the electrode wound body 20, that is, a detailed configuration of each of the positive electrode 21, the negative electrode 22, the separator 23, and the electrolytic solution will be described later.

In a typical lithium ion battery, for example, a lead for current extraction is welded at one location on each of the positive electrode and the negative electrode; however, this is not suitable for high-rate discharging because a high internal resistance of the battery will result and cause the lithium ion battery to generate heat and become high in temperature during discharging. To cope with this, in the lithium ion battery according to an embodiment, the internal resistance of the battery is kept low by disposing the positive electrode current collector plate 24 at the end face 41 and the negative electrode current collector plate 25 at the end face 42, and welding, at multiple points, the positive electrode current collector plate 24 and the negative electrode current collector plate 25 respectively to the active material uncovered part 21C of the positive electrode located at the end face 41 and the active material uncovered part 22C of the negative electrode located at the end face 42. The configuration in which the end faces 41 and 42 are bent to form flat surfaces also contributes to reduction in resistance.

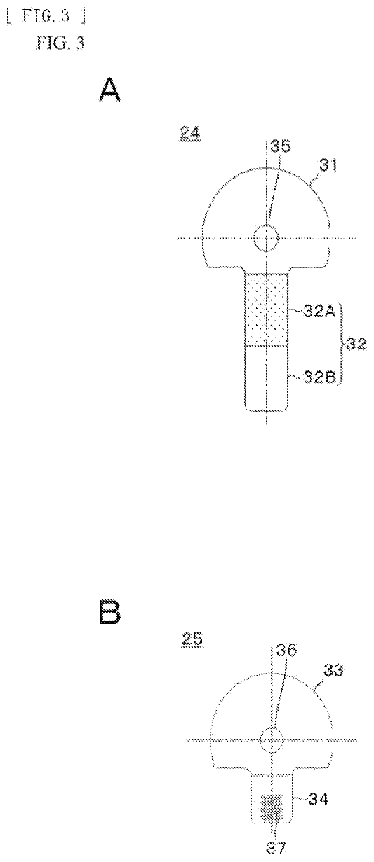

FIGS. 3A and 3B illustrate respective examples of the current collector plates. FIG. 3A illustrates the positive electrode current collector plate 24. FIG. 3B illustrates the negative electrode current collector plate 25. A material of the positive electrode current collector plate 24 is a metal plate including, for example, a simple substance or a composite material of aluminum or an aluminum alloy. A material of the negative electrode current collector plate 25 is a metal plate including, for example, a simple substance or a composite material of nickel, a nickel alloy, copper, or a copper alloy, that is, a cladding material. As illustrated in FIG. 3A, the positive electrode current collector plate 24 has a shape in which a band-like part 32 having a rectangular shape is attached to a plate-like part 31 having a flat fan shape. The plate-like part 31 has a hole 35 at a position near a middle thereof. The position of the hole 35 corresponds to that of the through hole 26.

A shaded region in FIG. 3A represents an insulating part 32A where an insulating tape or an insulating material is attached or applied to the band-like part 32. A region below the shaded region in FIG. 3A represents a coupling part 32B to be coupled to a sealing plate that also serves as an external terminal. Note that in a case of a battery structure without a metallic center pin (not illustrated) in the through hole 26, the insulating part 32A may be omitted because it is unlikely that the band-like part 32 will come into contact with a region of a negative electrode potential. In such a case, it is possible to increase charge and discharge capacities by increasing a width of each of the positive electrode 21 and the negative electrode 22 by an amount corresponding to a thickness of the insulating part 32A.

The negative electrode current collector plate 25 has a shape that is almost the same as the shape of the positive electrode current collector plate 24, but is different in band-like part. A band-like part 34 of the negative electrode current collector plate in FIG. 3B is shorter than the band-like part 32 of the positive electrode current collector plate, and includes no portion corresponding to the insulating part 32A. The band-like part 34 includes circular projections 37 depicted as multiple circles. Upon resistance welding, current is concentrated on the projections, and the projections thus melt to allow the band-like part 34 to be welded to the bottom of the battery can 11. Like the positive electrode current collector plate 24, the negative electrode current collector plate 25 has a hole 36 at a position near a middle of a plate-like part 33. The position of the hole 36 corresponds to that of the through hole 26. The plate-like part 31 of the positive electrode current collector plate 24 and the plate-like part 33 of the negative electrode current collector plate 25 each have a fan shape, and thus cover respective portions of the end faces 41 and 42. A reason for not covering all of each of the end faces is to allow the electrolytic solution to smoothly permeate the electrode wound body in assembling the battery, or to allow gas generated when the battery comes into an abnormally high-temperature state or an overcharged state to be easily released to the outside of the battery.

The positive electrode active material layer includes at least a positive electrode material (a positive electrode active material) into which lithium is insertable and from which lithium is extractable, and may further include, for example, a positive electrode binder and a positive electrode conductor. The positive electrode material is preferably a lithium-containing composite oxide or a lithium-containing phosphoric acid compound. The lithium-containing composite oxide has a layered rock-salt crystal structure or a spinel crystal structure, for example. The lithium-containing phosphoric acid compound has an olivine crystal structure, for example.

The positive electrode binder includes a synthetic rubber or a polymer compound. Examples of the synthetic rubber include a styrene-butadiene-based rubber, a fluorine-based rubber, and ethylene propylene diene. Examples of the polymer compound include polyvinylidene difluoride (PVdF) and polyimide.

The positive electrode conductor is a carbon material such as graphite, carbon black, acetylene black, or Ketjen black. Note that the positive electrode conductor may be a metal material or a polymer compound.

The positive electrode foil 21A preferably has a thickness within a range from 5 μm to 20 μm both inclusive. A reason for this is that setting the thickness of the positive electrode foil 21A to 5 μm or more allows for manufacture without breakage of the positive electrode 21 when the positive electrode 21, the negative electrode 22, and the separator 23 are laid over each other and wound. A further reason is that setting the thickness of the positive electrode foil 21A to 20 μm or less makes it possible to prevent a decrease in energy density of the battery 1 and allows the positive electrode 21 and the negative electrode 22 to be opposed to each other over a large area, thus allowing the battery 1 to have high output power.

The negative electrode foil 22A preferably has a surface roughened for improved adherence to the negative electrode active material layer. The negative electrode active material layer includes at least a negative electrode material (a negative electrode active material) into which lithium is insertable and from which lithium is extractable, and may further include, for example, a negative electrode binder and a negative electrode conductor.

The negative electrode material includes a carbon material, for example. The carbon material is graphitizable carbon, non-graphitizable carbon, graphite, low-crystalline carbon, or amorphous carbon. The carbon material has a fibrous shape, a spherical shape, a granular shape, or a flaky shape.

Further, the negative electrode material includes a metal-based material, for example. Examples of the metal-based material include Li (lithium), Si (silicon), Sn (tin), Al (aluminum), Zr (zinc), and Ti (titanium). A metallic element forms a compound, a mixture, or an alloy with another element, and examples thereof include silicon oxide (SiOₓ(0<x≤2)), silicon carbide (SiC), an alloy of carbon and silicon, and lithium titanium oxide (LTO).

The negative electrode foil 22A preferably has a thickness within a range from 5 μm to 20 μm both inclusive. A reason for this is that setting the thickness of the negative electrode foil 22A to 5 μm or more allows for manufacture without breakage of the negative electrode 22 when the positive electrode 21, the negative electrode 22, and the separator 23 are laid over each other and wound. A further reason is that setting the thickness of the negative electrode foil 22A to 20 μm or less makes it possible to prevent a decrease in energy density of the battery 1 and allows the positive electrode 21 and the negative electrode 22 to be opposed to each other over a large area, thus allowing the battery 1 to have high output power.

The separator 23 is a porous film including resin, and may be a layered film including two or more kinds of porous films. Examples of the resin include polypropylene and polyethylene. The separator 23 may include, with the porous film as a base layer, a resin layer provided on one surface or each of both surfaces of the base layer. A reason for this is that this improves adherence of the separator 23 to each of the positive electrode 21 and the negative electrode 22 and thus suppresses distortion of the electrode wound body 20.

The resin layer includes a resin such as PVdF. In a case of forming the resin layer, a solution including an organic solvent and the resin dissolved therein is applied on the base layer, following which the base layer is dried. Note that the base layer may be immersed in the solution and thereafter the base layer may be dried. From the viewpoint of improving heat resistance and battery safety, the resin layer preferably includes inorganic particles or organic particles. Examples of the kind of the inorganic particles include aluminum oxide, aluminum nitride, aluminum hydroxide, magnesium hydroxide, boehmite, talc, silica, and mica. Alternatively, a surface layer including inorganic particles as a main component and formed by a method such as a sputtering method or an atomic layer deposition (ALD) method may be used instead of the resin layer.

The separator 23 preferably has a thickness within a range from 4 μm to 30 μm both inclusive. Setting the thickness of the separator to 4 μm or more makes it possible to prevent an internal short circuit caused by contact between the positive electrode 21 and the negative electrode 22 which are opposed to each other with the separator 23 interposed therebetween. Setting the thickness of the separator 23 to 30 μm or less makes it possible for lithium ions and the electrolytic solution to easily pass through the separator 23, and makes it possible for the positive electrode 21 and the negative electrode 22 to achieve high electrode density when wound.

The electrolytic solution includes a solvent and an electrolyte salt, and may further include other materials such as additives on an as-needed basis. The solvent is a nonaqueous solvent such as an organic solvent, or water. The electrolytic solution including a nonaqueous solvent is called a nonaqueous electrolytic solution. Examples of the nonaqueous solvent include a cyclic carbonic acid ester, a chain carbonic acid ester, a lactone, a chain carboxylic acid ester, and a nitrile (mononitrile).

Although a typical example of the electrolyte salt is a lithium salt, the electrolyte salt may include any salt other than the lithium salt. Examples of the lithium salt include lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), and dilithium hexafluorosilicate (Li₂SF₆). These salts may also be used in mixture with each other. From the viewpoint of improving a battery characteristic, it is preferable to use a mixture of LiPF₆ and LiBF₄, in particular. Although not particularly limited, a content of the electrolyte salt is preferably in a range from 0.3 mol/kg to 3 mol/kg both inclusive with respect to the solvent.

A description will be given of a method of fabricating the lithium ion battery 1 according to the embodiment with reference to FIGS. 4A to 4F. First, the positive electrode active material was applied on the surface of the positive electrode foil 21A having a band shape to form the covered part of the positive electrode 21, and the negative electrode active material was applied on the surface of the negative electrode foil 22A having a band shape to form the covered part of the negative electrode 22. At this time, the active material uncovered part 21C without the positive electrode active material applied thereon and the active material uncovered part 22C without the negative electrode active material applied thereon were provided at one end in a transverse direction of the positive electrode 21 and one end in a transverse direction of the negative electrode 22, respectively. The cutouts were formed in respective portions of the active material uncovered parts 21C and 22C corresponding to the beginning of winding of the electrodes when wound. The positive electrode 21 and the negative electrode 22 were subjected to processes including a drying process. Thereafter, the positive electrode 21 and the negative electrode 22 were laid over each other with the separator 23 interposed therebetween in such a manner that the active material uncovered part 21C of the positive electrode and the active material uncovered part 22C of the negative electrode faced toward opposite directions, and they were wound in a spiral shape to allow the through hole 26 to be present on the central axis and to allow the formed cutouts to be located near the central axis. Thus, the electrode wound body 20 as illustrated in FIG. 4A was fabricated.

Next, as illustrated in FIG. 4B, the grooves 43 were formed in portions of the end faces 41 and 42 by pressing an end of a material such as a thin flat plate (for example, 0.5 mm in thickness) perpendicularly against each of the end faces 41 and 42. In this way, the grooves 43 were formed to extend radially from the through hole 26. The number and arrangement of the grooves 43 illustrated in FIG. 4B are merely one example. Thereafter, as illustrated in FIG. 4C, the end faces 41 and 42 were made into flat surfaces by applying equal pressures to the end faces 41 and 42 simultaneously from both electrode sides in directions substantially perpendicular to the end faces 41 and 42 and thereby bending portions of the active material uncovered part 21C of the positive electrode and portions of the active material uncovered part 22C of the negative electrode. At this time, a load was applied using, for example, a plate surface of a flat plate to cause the portions of the active material uncovered part located at the end face 41 to be bent toward the central axis and overlap with each other, and to cause the portions of the active material uncovered part located at the end face 42 to be bent toward the central axis and overlap with each other. Thereafter, the plate-like part 31 of the positive electrode current collector plate 24 was laser-welded to the end face 41, and the plate-like part 33 of the negative electrode current collector plate 25 was laser-welded to the end face 42.

Thereafter, as illustrated in FIG. 4D, the band-like parts 32 and 34 of the current collector plates 24 and 25 were bent and the insulating plates 12 and 13 (or insulating tapes) were respectively attached to the positive electrode current collector plate 24 and the negative electrode current collector plate 25. The electrode wound body 20 assembled in the above-described manner was placed into the battery can 11 illustrated in FIG. 4E, and the bottom of the battery can 11 was welded. The electrolytic solution was injected into the battery can 11, following which the battery can 11 was sealed with the gasket 15 and the battery cover 14 as illustrated in FIG. 4F.

### EXAMPLES

In the following, the present application will be described with reference to Examples, according to an embodiment, in which the lithium ion batteries 1 fabricated in the above-described manner were used to compare internal pressures of the batteries. Note that the present application is not limited to Examples described herein.

In each of all Examples and comparative examples described below, the size of the cylindrical battery was set to 21700 (21 mm in diameter and 70 mm in length), the number of the grooves 43 was set to eight, and the grooves 43 were arranged at substantially equal angular intervals. Laser welding was performed at positions arranged as illustrated in FIG. 5 to join the positive electrode current collector plate 24 and the active material uncovered part 21C of the positive electrode to each other, and to join the negative electrode current collector plate 25 and the active material uncovered part 22C of the negative electrode to each other. FIG. 5 is a schematic diagram depicted so that the end face 41 or 42 of the electrode wound body and the grooves 43 are seen through the current collector plate 24 or 25 in order to describe positions of laser welding marks. Thick solid-line portions in FIG. 5 represent laser welding marks 51. The laser welding marks 51 were each provided in a linear shape to extend from a position near the hole 35 or 36 to the perimeter, and were arranged at substantially equal angular intervals, one each between adjacent grooves 43. As illustrated in FIG. 5, six laser welding marks 51 were arranged in each of respective regions covered by the current collector plates 24 and 25. The laser welding marks 51 each had a length of 6 mm.

Conditions of fabricating the negative electrode foil (a copper foil) as the material of the negative electrode 22 were adjusted to fabricate the negative electrode foils (the copper foils) having surfaces that vary in glossiness. On the negative electrode foil (the copper foil) before being covered with the negative electrode active material, light was caused to be incident in the transverse direction of the negative electrode 22 to thereby measure the glossiness. The negative electrode foil mentioned here is basically the same as the negative electrode foil 22A and the active material uncovered part 22C of the negative electrode after fabrication of the negative electrode. Note that the measurement of the glossiness may be performed on the negative electrode foil (the copper foil) before being covered with the negative electrode active material, or on the copper foil taken out of the completed battery. After the battery is completely discharged, the battery is disassembled and the wound body is unwound to separate a negative electrode plate, following which the negative electrode plate is washed with, for example, dimethyl carbonate (DMC) and dried. Thereafter, an exposed part of the copper foil, that is, the part on which the active material is not applied, is cut into a predetermined size from the negative electrode plate. A piece of the copper foil separated in such a manner may be subjected to the measurement of the glossiness. In the disclosure, the glossiness refers to one that is measured in accordance with JIS Z 8741: 1997 and corresponds to Gs(60°) obtained with an incident angle of light of 60°. Gs(60°) represents a value with respect to a value of a specular glossiness at a glass surface having a refractive index of 1.567 assumed as 100. The negative electrode was fabricated with a negative electrode foil of which glossiness had been measured in advance, and the lithium ion battery 1 was assembled. It is preferred that the negative electrode foil (the copper foil) have a thickness in a range from 5 μm to 20 μm both inclusive.

An electrolytic copper foil was used as the negative electrode foil (the copper foil) as the material of the negative electrode 22. The electrolytic copper foil can be manufactured by allowing copper plating to be continuously deposited on a surface of a rotating drum serving as a cathode, and stripping and winding up the deposited copper plating from the drum. Of the electrolytic copper foil thus manufactured, a surface (a drum-side surface) that has been in contact with the drum and a surface (a deposition surface) that has been on a liquid side and on which the copper plating has been deposited are different in property. The drum-side surface is low in surface roughness and high in glossiness, reflecting a polished state of the surface of the drum with high fidelity. In addition, the drum-side surface, which serves as a deposition-start side, tends to be small in crystal grain size and small in variation in crystal grain size. In contrast, the deposition surface, from which crystal has grown, tends to be high in surface roughness, low in glossiness, large in crystal gran size, and large in variation in crystal grain size.

In the electrode wound body described above, by allowing an inner surface of winding of the negative electrode foil (the copper foil) to be the drum-side surface and allowing an outer surface of the winding of the negative electrode foil (the copper foil) to be the deposition surface, the portions of the negative electrode foil (the copper foil) are bent at uniform positions and thus overlap and align with each other over an entire perimeter, which makes it possible to increase the flatness of the end face 42. In contrast, in a case where the inner surface of the winding is the deposition surface and the outer surface of the winding is the drum-side surface, bending positions of the portions of the negative electrode foil (the copper foil) often vary greatly, or the portions of the negative electrode foil (the copper foil) are often bent in S-shapes. Accordingly, the flatness of the end face 42 is degraded.

The drum-side surface of the negative electrode foil (the copper foil) has a high yield stress due to a small crystal grain size, and has a substantially uniform yield stress due to a small variation in crystal grain size. In a case where the electrode wound body is fabricated with the inner surface of the winding of the negative electrode foil (the copper foil) being the drum-side surface and with the outer surface of the winding of the negative electrode foil (the copper foil) being the deposition surface, the negative electrode foil withstands as long as an inwardly bending force is smaller than the yield stress; however, once the inwardly bending force has exceeded the yield stress, portions of the negative electrode foil are bent at uniform positions all at once radially inwardly from a perimeter side of the electrode wound body. It is considered that, as a result, the portions of the negative electrode foil (the copper foil) located on an edge side relative to the bending positions overlap and align with each other, thereby increasing the flatness of the end face 42.

In contrast, the deposition surface of the negative electrode foil (the copper foil) has a low yield stress due to a large crystal grain size, and is large in variation in yield stress due to a large variation in crystal grain size. In a case where the electrode wound body is fabricated with the inner surface of the winding being the deposition surface and with the outer surface of the winding being the drum-side surface, the portions of the negative electrode foil (the copper foil) are bent at positions that vary depending on the yield stress. It is considered that, as a result, the portions of the negative electrode foil (the copper foil) come into a disorderly state without aligning with each other, so that depressions develop partly in the end face 42, resulting in a low flatness of the end face 42.

In the following description, of both major surfaces (a front side and a back side) of the negative electrode foil, one major surface (a first major surface) that is to face toward the central axis (the through hole 26) of the electrode wound body 20 when the electrode wound body 20 including the negative electrode 22 is fabricated is referred to as the inner surface of the winding, and another surface (a second major surface) that is to face away from the central axis (the through hole 26) of the electrode wound body is referred to as the outer surface of the winding. The negative electrode 22 was fabricated to be different in glossiness between the inner surface of the winding and the outer surface of the winding. Copper was used as the material of the negative electrode foil, and a thickness of the negative electrode foil was set to 10 μm.

For all of Examples and comparative examples described below, unless otherwise specified, D was set to 3 mm where D is the length of the portion of the active material uncovered part 22C of the negative electrode protruding from the other end in the width direction of the separator 23 in the pre-winding structure in which the positive electrode 21, the negative electrode 22, and the separator 23 are stacked, as illustrated in FIG. 2.

First, negative electrode foils (copper foils) in each of which a glossiness of the inner surface of the winding was higher than a glossiness of the outer surface of the winding were studied.

### Examples 1 to 3

A copper foil in which the glossiness of the inner surface of the winding was higher than the glossiness of the outer surface of the winding was prepared, and the negative electrode 22 was fabricated using this copper foil to thereby fabricate the battery 1.

### Comparative Examples 1 to 3

A copper foil in which the glossiness of the inner surface of the winding was lower than or equal to the glossiness of the outer surface of the winding was prepared, and the negative electrode 22 was fabricated using this copper foil to thereby fabricate the battery 1.

The above-described batteries 1 were each evaluated by measuring an internal resistance (DCR) of the battery 1. A direct-current resistance is obtainable by calculating a gradient of voltage when a discharge current is increased from 0 (A) to 100 (A) in five seconds. The number of the batteries 1 subjected to the measurement was 30 for each of Examples and the comparative examples. The internal resistance (DCR) of the battery 1 represents an average of measurement values of the 30 batteries 1. Cases where the internal resistance (DCR) of the battery 1 was 11.0 mΩ or less were determined as PASS, and the other cases were determined as FAIL. The results are given in Table 1 below.

TABLE 1

| | | | Difference | |
|---|---|---|---|---|
| | | | between | |
| | | | glossiness | |
| | | | of inner | |
| | | | surface of | |
| | | | winding and | |
| | Glossiness | Glossiness | glossiness | Internal |
| | of inner | of outer | of outer | resistance |
| | surface of | surface of | surface of | DCR (mΩ) |
| | winding | winding | winding | of battery |
| Example 1 | 195 | 120 | 75 | 10.19 |
| Example 2 | 182 | 118 | 64 | 10.20 |
| Example 3 | 172 | 122 | 50 | 10.24 |
| Comparative | 111 | 113 | −2 | 14.89 |
| example 1 | | | | |
| Comparative | 120 | 130 | −10 | 15.25 |
| example 2 | | | | |
| Comparative | 115 | 122 | −7 | 13.98 |
| example 3 | | | | |

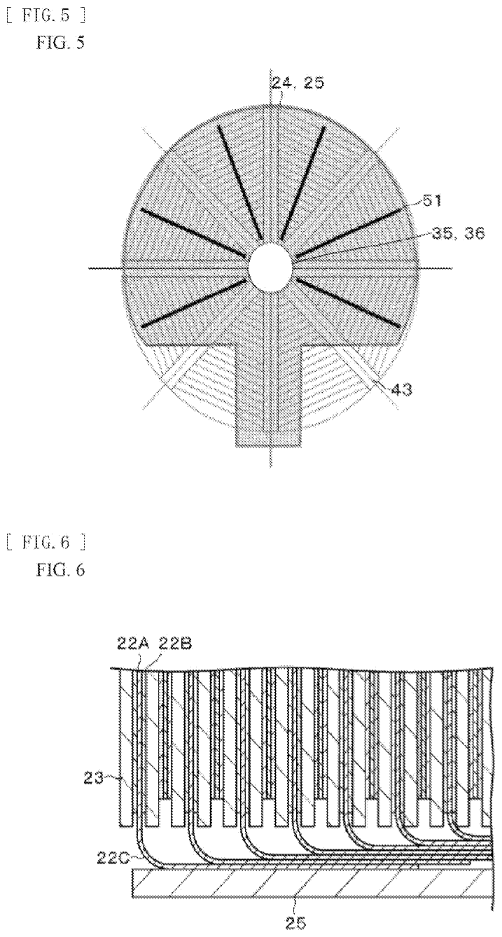

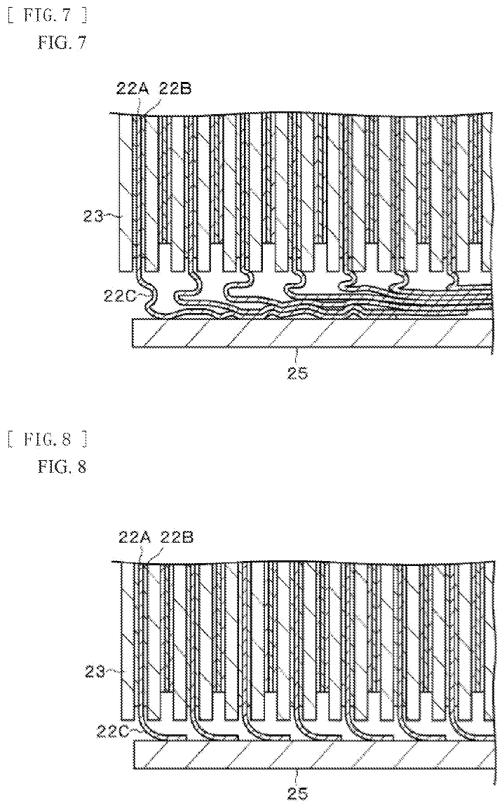

In Examples 1 to 3, the values of the internal resistance of the battery 1 were 11.0 mΩ or less (determination: PASS), and no welding defects such as hole generation or spatters occurred, whereas in Comparative examples 1 to 3, the values of the internal resistance of the battery 1 were greater than 11.0 mΩ (determination: FAIL), and welding defects occurred. Regarding Examples 1 to 3, it is considered that as illustrated in FIG. 6, the portions of the active material uncovered part 22C of the negative electrode were bent at uniform positions toward the central axis of the electrode wound body 20, so that the portions of the active material uncovered part 22C located on the edge side relative to the bending positions overlapped and aligned with each other, which allowed the end face 42 to form a flat surface. Regarding Comparative examples 1 to 3, it is considered that as illustrated in FIG. 7, the portions of the active material uncovered part 22C of the negative electrode were bent at respective different positions into S-shapes, and came into a disorderly state without aligning with each other, which resulted in projections and depressions in the end face 42 and thus caused the end face 42 to have regions of low flatness. According to Examples, it is possible for the end face 42 and the negative electrode current collector plate 25 to be in close contact with each other without any gap therebetween, which prevents the occurrence of laser welding defects. This is considered to be a reason for the low internal resistance of the battery 1. From Table 1, it is determinable that the internal resistance of the battery is low in a case where the glossiness of the inner surface of the winding of the negative electrode foil is higher than the glossiness of the outer surface of the winding of the negative electrode foil.

Next, regarding the negative electrode foils (the copper foils) in each of which the glossiness of the inner surface of the winding was higher than the glossiness of the outer surface of the winding, cases where the glossiness of the inner surface of the winding was greater than or equal to a certain value (150 or 200) and cases where the glossiness of the inner surface of the winding was less than the certain value were studied.

### Examples 4 to 6

A copper foil in which the glossiness of the inner surface of the winding was higher than the glossiness of the outer surface of the winding and in which the glossiness of the inner surface of the winding was greater than or equal to 150 was prepared, and the negative electrode 22 was fabricated using this copper foil to thereby fabricate the battery 1.

### Examples 7 to 9

A copper foil in which the glossiness of the inner surface of the winding was higher than the glossiness of the outer surface of the winding and in which the glossiness of the inner surface of the winding was greater than or equal to 200 was prepared, and the negative electrode 22 was fabricated using this copper foil to thereby fabricate the battery 1.

### Examples 10 to 12

A copper foil in which the glossiness of the inner surface of the winding was higher than the glossiness of the outer surface of the winding and in which the glossiness of the inner surface of the winding was less than 150 was prepared, and the negative electrode 22 was fabricated using this copper foil to thereby fabricate the battery 1.

The batteries 1 of Examples 4 to 12 were evaluated in a manner similar to that described above. The results are given in Table 2 below.

TABLE 2

| | | | Difference | |
|---|---|---|---|---|
| | | | between | |
| | | | glossiness | |
| | | | of inner | |
| | | | surface of | |
| | | | winding and | |
| | Glossiness | Glossiness | glossiness | Internal |
| | of inner | of outer | of outer | resistance |
| | surface of | surface of | surface of | DCR (mΩ) |
| | winding | winding | winding | of battery |
| Example 4 | 187 | 108 | 79 | 10.35 |
| Example 5 | 180 | 105 | 75 | 10.42 |
| Example 6 | 170 | 99 | 71 | 10.33 |
| Example 7 | 205 | 127 | 78 | 10.08 |
| Example 8 | 202 | 128 | 74 | 10.10 |
| Example 9 | 204 | 125 | 79 | 10.15 |
| Example 10 | 145 | 89 | 56 | 10.56 |
| Example 11 | 143 | 91 | 52 | 10.64 |
| Example 12 | 148 | 93 | 55 | 10.61 |

In Examples 4 to 12, the values of the internal resistance of the battery were 11.0 mΩ or less (determination: PASS), and no welding defects occurred. The values of the internal resistance of the battery 1 in Examples 4 to 6 were lower than those in Examples 10 to 12, and the values of the internal resistance of the battery 1 in Examples 7 to 9 were lower than those in Examples 4 to 6. From Table 2, it is determinable that the internal resistance of the battery 1 is low in a case where the negative electrode foil has a higher glossiness at the inner surface of the winding than at the outer surface of the winding and where the glossiness of the inner surface of the winding is greater than or equal to 150. In particular, it is determinable that the internal resistance of the battery 1 is lower in a case where the negative electrode foil has a higher glossiness at the inner surface of the winding than at the outer surface of the winding and where the glossiness of the inner surface of the winding is greater than or equal to 200.

Next, regarding the negative electrode foils (the copper foils) in each of which the glossiness of the inner surface of the winding was higher than the glossiness of the outer surface of the winding, cases where the glossiness of the outer surface of the winding was greater than or equal to a certain value (110 or 130) and cases where the glossiness of the outer surface of the winding was less than the certain value were studied.

### Examples 13 to 15

A negative electrode foil (a copper foil) in which the glossiness of the inner surface of the winding was higher than the glossiness of the outer surface of the winding and in which the glossiness of the outer surface of the winding was greater than or equal to 110 was prepared, and the negative electrode 22 was fabricated using this copper foil to thereby fabricate the battery 1.

### Examples 16 to 18

A negative electrode foil (a copper foil) in which the glossiness of the inner surface of the winding was higher than the glossiness of the outer surface of the winding and in which the glossiness of the outer surface of the winding was greater than or equal to 130 was prepared, and the negative electrode 22 was fabricated using this copper foil to thereby fabricate the battery 1.

### Examples 19 to 21

A negative electrode foil (a copper foil) in which the glossiness of the inner surface of the winding was higher than the glossiness of the outer surface of the winding and in which the glossiness of the outer surface of the winding was less than 110 was prepared, and the negative electrode 22 was fabricated using this copper foil to thereby fabricate the battery 1.

The batteries of Examples 13 to 21 were evaluated in a manner similar to that described above. The results are given in Table 3 below.

TABLE 3

| | | | Difference | |
|---|---|---|---|---|
| | | | between | |
| | | | glossiness | |
| | | | of inner | |
| | | | surface of | |
| | | | winding and | |
| | Glossiness | Glossiness | glossiness | Internal |
| | of inner | of outer | of outer | resistance |
| | surface of | surface of | surface of | DCR (mΩ) |
| | winding | winding | winding | of battery |
| Example 13 | 195 | 120 | 75 | 10.19 |
| Example 14 | 182 | 118 | 64 | 10.20 |
| Example 15 | 172 | 122 | 50 | 10.24 |
| Example 16 | 191 | 135 | 56 | 10.08 |
| Example 17 | 195 | 140 | 55 | 10.12 |
| Example 18 | 199 | 142 | 57 | 10.14 |
| Example 19 | 187 | 108 | 79 | 10.35 |
| Example 20 | 180 | 105 | 75 | 10.42 |
| Example 21 | 170 | 99 | 71 | 10.33 |

In Examples 13 to 21, the internal resistance of the battery was 11.0 mΩ or less (determination: PASS), and no welding defects occurred. The values of the internal resistance in Examples 13 to 15 were lower than those in Examples 19 to 21, and the values of the internal resistance in Examples 16 to 18 were lower than those in Examples 13 to 15. From Table 3, it is determinable that the internal resistance of the battery 1 is low in a case where the negative electrode foil has a higher glossiness at the inner surface of the winding than at the outer surface of the winding and where the glossiness of the outer surface of the winding is greater than or equal to 110. In particular, it is determinable that the internal resistance of the battery 1 is lower in a case where the negative electrode foil has a higher glossiness at the inner surface of the winding than at the outer surface of the winding and where the glossiness of the outer surface of the winding is greater than or equal to 130.

Next, regarding the negative electrode foils (the copper foils) in each of which the glossiness of the inner surface of the winding was higher than the glossiness of the outer surface of the winding, cases where a difference between the glossiness of the inner surface of the winding and the glossiness of the outer surface of the winding was greater than or equal to a certain value (50 or 80) and cases where the difference between the glossiness of the inner surface of the winding and the glossiness of the outer surface of the winding was less than the certain value were studied.

### Examples 22 to 24

The negative electrode 22 was fabricated using a negative electrode foil (a copper foil) in which the glossiness of the inner surface of the winding was higher than the glossiness of the outer surface of the winding and in which the difference between the glossiness of the inner surface of the winding and the glossiness of the outer surface of the winding was greater than or equal to 50, and the battery 1 was fabricated.

### Examples 25 to 27

The negative electrode 22 was fabricated using a negative electrode foil (a copper foil) in which the glossiness of the inner surface of the winding was higher than the glossiness of the outer surface of the winding and in which the difference between the glossiness of the inner surface of the winding and the glossiness of the outer surface of the winding was greater than or equal to 80, and the battery 1 was fabricated.

### Examples 28 to 30

The negative electrode 22 was fabricated using a negative electrode foil (a copper foil) in which the glossiness of the inner surface of the winding was higher than the glossiness of the outer surface of the winding and in which the difference between the glossiness of the inner surface of the winding and the glossiness of the outer surface of the winding was less than 50, and the battery 1 was fabricated.

The batteries of Examples 22 to 30 were evaluated in a manner similar to that described above. The results are given in Table 4 below.

TABLE 4

| | | | Difference | |
|---|---|---|---|---|
| | | | between | |
| | | | glossiness | |
| | | | of inner | |
| | | | surface of | |
| | | | winding and | |
| | Glossiness | Glossiness | glossiness | Internal |
| | of inner | of outer | of outer | resistance |
| | surface of | surface of | surface of | DCR (mΩ) |
| | winding | winding | winding | of battery |
| Example 22 | 205 | 127 | 78 | 10.08 |
| Example 23 | 202 | 128 | 74 | 10.10 |
| Example 24 | 204 | 125 | 79 | 10.15 |
| Example 25 | 210 | 125 | 85 | 10.01 |
| Example 26 | 224 | 128 | 96 | 10.06 |
| Example 27 | 209 | 118 | 91 | 10.04 |
| Example 28 | 199 | 152 | 47 | 10.40 |
| Example 29 | 190 | 155 | 35 | 10.31 |
| Example 30 | 182 | 148 | 34 | 10.36 |

In Examples 22 to 30, the internal resistance of the battery was 11.0 mΩ or less (determination: PASS), and no welding defects occurred. The values of the internal resistance of the battery 1 in Examples 22 to 24 were lower than those in Examples 28 to 30, and the values of the internal resistance in Examples 25 to 27 were lower than those in Examples 22 to 24. From Table 4, it is determinable that the internal resistance of the battery 1 is low in a case where the negative electrode foil (the copper foil) has a higher glossiness at the inner surface of the winding than at the outer surface of the winding and where the difference between the glossiness of the inner surface of the winding and the glossiness of the outer surface of the winding is greater than or equal to 50. In particular, it is determinable that the internal resistance of the battery 1 is lower in a case where the negative electrode foil (the copper foil) has a higher glossiness at the inner surface of the winding than at the outer surface of the winding and where the difference between the glossiness of the inner surface of the winding and the glossiness of the outer surface of the winding is greater than or equal to 80.

Next, the batteries 1 with varying lengths D were studied. The length D is, in the pre-winding structure in which the positive electrode 21, the negative electrode 22, and the separator 23 are stacked as illustrated in FIG. 2, the length of the portion of the active material uncovered part 22C of the negative electrode protruding from the other end in the width direction of the separator 23.

### Example 31

A copper foil similar to that of Example 1 was prepared, and the negative electrode 22 was fabricated using this copper foil to thereby fabricate the battery 1. D was set to 3 mm.

### Comparative Example 4

Comparative example 4 was similar to Example 31 except that D was set to 2 mm.

The batteries of Example 31 and Comparative example 4 were evaluated in a manner similar to that described above. The results are given in Table 5 below.

TABLE 5

| | | | Difference | | |
|---|---|---|---|---|---|
| | | | between | | |
| | | | glossiness | | |
| | | | of inner | | |
| | | | surface of | | |
| | | | winding and | | |
| | Glossiness | Glossiness | glossiness | | Internal |
| | of inner | of outer | of outer | | resistance |
| | surface of | surface of | surface of | D | DCR (mΩ) |
| | winding | winding | winding | (mm) | of battery |
| Example 31 | 195 | 120 | 75 | 3 | 10.19 |
| Comparative | 195 | 120 | 75 | 2 | 14.92 |
| example 4 | | | | | |

In Example 31, the value of the internal resistance of the battery 1 was 11.0 mΩ or less (determination: PASS), and no welding defects occurred, whereas in Comparative example 4, the value of the internal resistance of the battery 1 was greater than 11.0 mΩ (determination: FAIL), and welding defects such as hole generation or spatters occurred. Regarding Example 31, as with Example 1, it is considered that as illustrated in FIG. 6, the portions of the active material uncovered part 22C of the negative electrode were bent in one direction toward the central axis of the electrode wound body 20 and favorably overlapped with each other. Regarding Comparative example 4, it is considered that as illustrated in FIG. 8, the active material uncovered part 22C of the negative electrode was small in length and accordingly, an area of overlap between the portions of the active material uncovered part 22C of the negative electrode that were bent and overlapped with each other was small, or the portions of the active material uncovered part 22C of the negative electrode forming the end face 42 had spaces therebetween. It is considered that according to Example 31 in which the portions of the active material uncovered part 22C of the negative electrode align and overlap with each other, no laser welding defects occur and accordingly, the internal resistance of the battery 1 is relatively low. Although D=3 mm in Example 31, it is considered that the same holds true for D>3 mm. From Table 5, it is determinable that the internal resistance of the battery 1 is low in a case where the portion of the active material uncovered part 22C of the negative electrode protruding from the other end in the width direction of the separator 23 has a length of 3 mm or more.

Although one or more embodiments of the present application have been described herein, the contents of the present application are not limited thereto, and various modifications thereof may be made.

In an embodiment, as illustrated in FIG. 5, one laser welding mark is provided between two adjacent grooves 43; however, multiple laser welding marks may be provided between two adjacent grooves 43. In such a case, the internal resistance of the battery is further reduced owing to a further increase in area of the laser welding marks.

Although the number of the grooves 43 is eight in Examples and the comparative examples, any other number may be employed. Although the battery size employed is 21700 (21 mm in diameter and 70 mm in height) in a cylindrical shape, 18650 (18 mm in diameter and 65 mm in height) or any other size may be employed.

Although the positive electrode current collector plate 24 and the negative electrode current collector plate 25 respectively include the plate-like parts 31 and 33 each shaped like a fan, any other shape may be employed.

In an embodiment, the positive electrode 21 and the negative electrode 22 respectively have a structure in which portions of the active material uncovered part 21C are bent to be welded to the current collector plate 24 and a structure in which portions of the active material uncovered part 22C are bent to be welded to the current collector plate 25; however, the positive electrode 21 may have any other structure.

The present application is applicable to any suitable battery other than the lithium ion battery, and to any battery having a suitable shape other than the cylindrical shape, such as a laminated battery, a prismatic battery, a coin-type battery, or a button-type battery, without departing from the scope of the present application. In such a case, the shape of the “end face of the electrode wound body” is not limited to a circular shape, and may be any of other suitable shapes including, without limitation, an elliptical shape and an elongated shape.

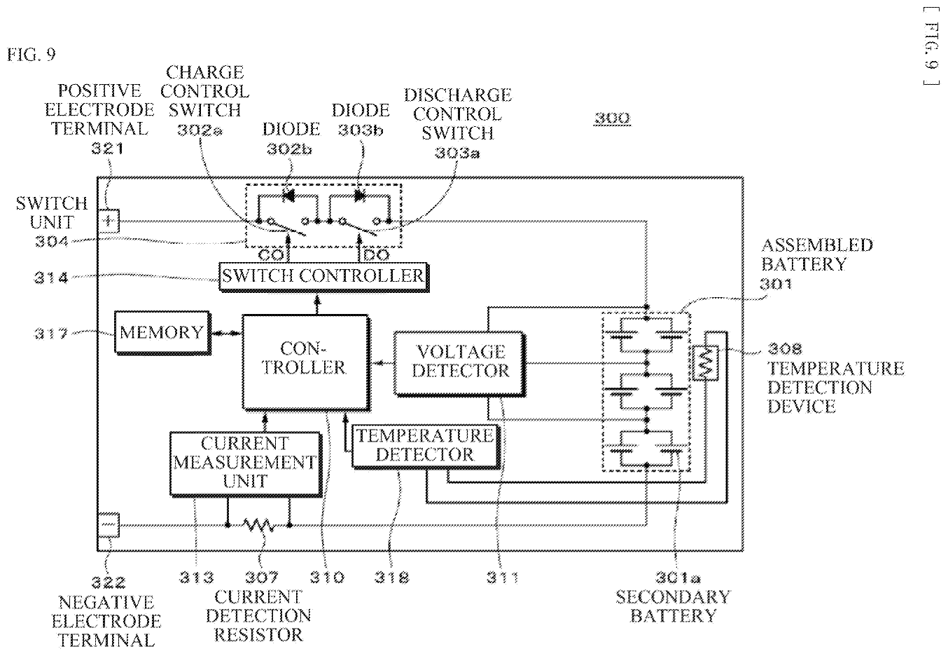

FIG. 9 is a block diagram illustrating a circuit configuration example where the battery 1 according to an embodiment including Examples of the present application is applied to a battery pack 300. The battery pack 300 includes an assembled battery 301, a switch unit 304, a current detection resistor 307, a temperature detection device 308, and a controller 310. The switch unit 304 includes a charge control switch 302a and a discharge control switch 303a. The controller 310 controls each device. Further, the controller 310 is able to perform charge and discharge control upon abnormal heat generation, and to perform calculation and correction of a remaining capacity of the battery pack 300. The battery pack 300 includes a positive electrode terminal 321 and a negative electrode terminal 322 that are couplable to a charger or electronic equipment for charging and discharging.

The assembled battery 301 includes multiple secondary batteries 301a coupled in series or in parallel. FIG. 9 illustrates an example case in which six secondary batteries 301a are coupled in a two parallel coupling and three series coupling (2P3S) configuration.

A temperature detector 318 is coupled to the temperature detection device 308 (for example, a thermistor). The temperature detector 318 measures the temperature of the assembled battery 301 or the battery pack 300, and supplies the measured temperature to the controller 310. A voltage detector 311 measures the voltages of the assembled battery 301 and each of the secondary batteries 301a included therein, performs A/D conversion on the measured voltages, and supplies the converted voltages to the controller 310. A current measurement unit 313 measures currents using the current detection resistor 307 and supplies the measured currents to the controller 310.

A switch controller 314 controls the charge control switch 302a and the discharge control switch 303a of the switch unit 304 based on the voltages and the currents respectively supplied from the voltage detector 311 and the current measurement unit 313. When the voltage of any of the secondary batteries 301a becomes higher than or equal to an overcharge detection voltage or becomes lower than or equal to an overdischarge detection voltage, the switch controller 314 transmits a turn-off control signal to the switch unit 304 to thereby prevent overcharging or overdischarging. The overcharge detection voltage is, for example, 4.20 V±0.05 V. The overdischarge detection voltage is, for example, 2.4 V±0.1 V.

After the charge control switch 302a or the discharge control switch 303a is turned off, charging or discharging is enabled only through a diode 302b or a diode 303b. Semiconductor switches such as MOSFETs are employable as these charge and discharge control switches. Note that although the switch unit 304 is provided on a positive side in FIG. 9, the switch unit 304 may be provided on a negative side.

A memory 317 includes a RAM and a ROM. Numerical values including, for example, battery characteristic values, a full charge capacity, and a remaining capacity calculated by the controller 310 are stored and rewritten therein.

The battery 1 according to an embodiment including Examples of the present application described herein is mountable on equipment such as electronic equipment, electric transport equipment, or a power storage apparatus, and is usable to supply electric power.

Examples of the electronic equipment include laptop personal computers, smartphones, tablet terminals, personal digital assistants (PDAs) (mobile information terminals), mobile phones, wearable terminals, digital still cameras, electronic books, music players, game machines, hearing aids, electric tools, televisions, lighting equipment, toys, medical equipment, and robots. In addition, electric transport equipment, power storage apparatuses, and electric unmanned aerial vehicles, which will be described later, may also be included in the electronic equipment in a broad sense.

Examples of the electric transport equipment include electric automobiles (including hybrid electric automobiles), electric motorcycles, electric-assisted bicycles, electric buses, electric carts, automated guided vehicles (AGVs), and railway vehicles. Examples of the electric transport equipment further include electric passenger aircrafts and electric unmanned aerial vehicles for transportation. The secondary battery according to the disclosure is used not only as a driving power source for the foregoing electric transport equipment but also as, for example, an auxiliary power source or an energy-regenerative power source therefor.

Examples of the power storage apparatuses include a power storage module for commercial or household use, and a power source for power storage for architectural structures including residential houses, buildings, and offices, or for power generation facilities.

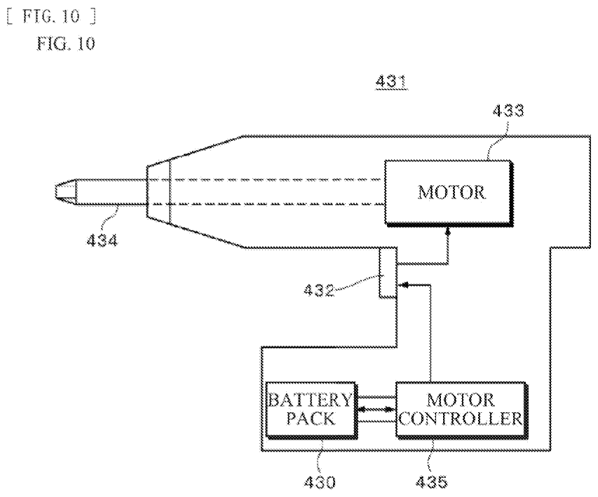

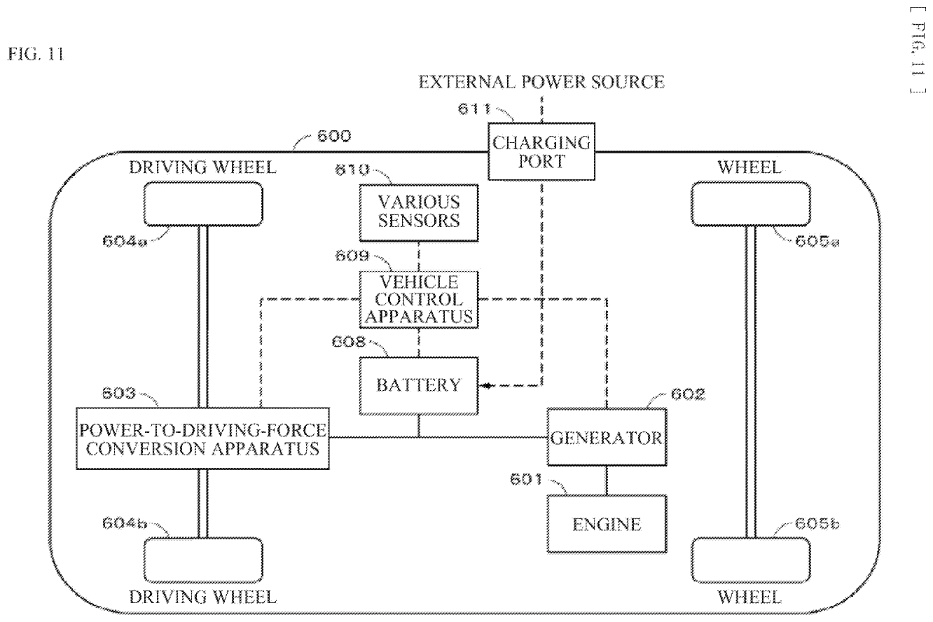

As an example of the electric tools to which the present application is applicable, an electric screwdriver will be schematically described with reference to FIG. 10. An electric screwdriver 431 includes a motor 433 and a trigger switch 432. The motor 433 transmits rotational power to a shaft 434. The trigger switch 432 is operated by a user. A battery pack 430 according to the disclosure and a motor controller 435 are contained in a lower housing of a handle of the electric screwdriver 431. The battery pack 430 is built in or detachably attached to the electric screwdriver 431. The battery 1 according to an embodiment is applicable to a battery included in the battery pack 430.

The battery pack 430 and the motor controller 435 may include respective microcomputers (not illustrated) communicable with each other to transmit and receive charge and discharge data on the battery pack 430. The motor controller 435 controls operation of the motor 433, and is able to cut off power supply to the motor 433 under abnormal conditions such as overdischarging.

As an example of application of the present application to a power storage system for electric vehicles, FIG. 11 schematically illustrates a configuration example of a hybrid vehicle (HV) that employs a series hybrid system. The series hybrid system relates to a vehicle that travels with an electric-power-to-driving-force conversion apparatus, using electric power generated by a generator that uses an engine as a power source, or using electric power temporarily stored in a battery.

A hybrid vehicle 600 is equipped with an engine 601, a generator 602, an electric-power-to-driving-force conversion apparatus 603 (a direct-current motor or an alternating-current motor; hereinafter, simply “motor 603”), a driving wheel 604a, a driving wheel 604b, a wheel 605a, a wheel 605b, a battery 608, a vehicle control apparatus 609, various sensors 610, and a charging port 611. The battery pack 300 according to an embodiment, or a power storage module equipped with a plurality of batteries 1 according to an embodiment is applicable to the battery 608.

The motor 603 operates under the electric power of the battery 608, and a rotational force of the motor 603 is transmitted to the driving wheels 604a and 604b. Electric power generated by the generator 602 using a rotational force generated by the engine 601 is storable in the battery 608. The various sensors 610 control an engine speed via the vehicle control apparatus 609, and control an opening angle of an unillustrated throttle valve.

When the hybrid vehicle 600 is decelerated by an unillustrated brake mechanism, a resistance force at the time of deceleration is applied to the motor 603 as a rotational force, and regenerative electric power generated from the rotational force is stored in the battery 608. In addition, the battery 608 is chargeable by being coupled to an external power source via the charging port 611 of the hybrid vehicle 600. Such an HV vehicle is referred to as a plug-in hybrid vehicle (PHV or PHEV).

Note that the secondary battery according to an embodiment may be applied to a small-sized primary battery and used as a power source of an air pressure sensor system (a tire pressure monitoring system: TPMS) built in the wheels 604 and 605.

Although the series hybrid vehicle has been described above as an example, the present application is applicable also to a hybrid vehicle of a parallel system in which an engine and a motor are used in combination, or of a combination of the series system and the parallel system. Furthermore, the disclosure is applicable to an electric vehicle (EV or BEV) and a fuel cell vehicle (FCV) that travel by means of only a driving motor without using an engine.

### REFERENCE SIGNS LIST

1: lithium ion battery
12: insulating plate
21: positive electrode
21A: positive electrode foil
21B: positive electrode active material covered part
21C: active material uncovered part of a positive electrode
22: negative electrode
22A: negative electrode foil
22B: negative electrode active material covered part
22C: active material uncovered part of a negative electrode
23: separator
24: positive electrode current collector plate
25: negative electrode current collector plate
26: through hole
27, 28: outer edge part
41, 42: end face
43: groove
51: laser welding mark

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body having a structure in which a positive electrode having a band shape and a negative electrode having a band shape are stacked and provided with a separator interposed therebetween, and are in a wound configuration;
a positive electrode current collector plate;
a negative electrode current collector plate; and
an outer package containing the electrode wound body, the positive electrode current collector plate, and the negative electrode current collector plate, wherein
the negative electrode includes, on a negative electrode foil having a band shape, a negative electrode active material covered part covered with a negative electrode active material layer, and a negative electrode active material uncovered part,
the electrode wound body has a flat surface, in which portions of the negative electrode active material uncovered part that protrude from one end of the electrode wound body are bent toward a central axis of the electrode wound body to form the flat surface,
the flat surface is coupled to the negative electrode current collector plate,
the negative electrode foil has a first major surface facing toward the central axis, and a second major surface facing away from the central axis, and
where a glossiness of the first major surface is denoted as G1 and a glossiness of the second major surface is denoted as G2, G1>G2 is satisfied.

2. The secondary battery according to claim 1, wherein G1-G2>50 is satisfied.

3. The secondary battery according to claim 1, wherein G1-G2>80 is satisfied.

4. The secondary battery according to claim 1, wherein G1>150 is satisfied.

5. The secondary battery according to claim 1, wherein G1>200 is satisfied.

6. The secondary battery according to claim 2, wherein G2>110 is satisfied.

7. The secondary battery according to claim 2, wherein G2>130 is satisfied.

8. The secondary battery according to claim 1, wherein a portion of the negative electrode active material uncovered part protruding from another end in a width direction of the separator has a length greater than or equal to 3 millimeters.

9. The secondary battery according to claim 1, wherein
a material of the negative electrode foil includes copper or a copper alloy, and
the negative electrode foil has a thickness greater than or equal to 5 micrometers and less than or equal to 20 micrometers.

10. The secondary battery according to claim 1, wherein
the electrode wound body has a second flat surface, in which portions of a positive electrode active material uncovered part that protrude from one end of the electrode wound body are bent toward the central axis of the electrode wound body to form the second flat surface, and
the second flat surface is coupled to the positive electrode current collector plate.

11. Electronic equipment comprising the secondary battery according to claim 1.

12. An electric tool comprising the secondary battery according to claim 1.
